(19) United States
(12) Patent Application Publication
(10) Pub. No.: US 2008/0273478 A1
(43) Pub. Date: Nov. 6, 2008

(54) Method for Fairly Distribution of Spectrum in Contention-Based Protocols

(75) Inventors: Wolfgang Budde, Aachen (DE); Salvador Expedito Boleko Ribas, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,802

(22) PCT Filed: Jun. 23, 2005
(86) PCT No.: PCT/IB05/52075

§ 371 Date: Dec. 18, 2006

(30) Foreign Application Priority Data
Jun. 30, 2004 (EP) 04103057.8

(51) Int. Cl. G08C 17/00

(52) U.S. Cl. 370/311

(57) ABSTRACT

The invention relates to a method and a terminal for wireless transmitting data using a contention-based protocol, wherein a plurality of communicating wireless terminals (1-9) transmit data using a common medium for transmitting, the method within a wireless terminal comprises the steps of: waiting for a back-off time to access the medium, observing whether the medium is idle, transmitting the data if the medium is idle, registering an amount of used transmit power and adjusting features of the wireless terminal to reward the wireless terminal in dependence of the used transmit power. The proposed method will reduce the overall emitted power and the risk of interferences and will thereby improve the quality of service. The back-off time of the wireless terminal and/or a priority of a data packet to be transmitted are determined in dependence of the amount of used transmit power.

The invention relates to a method for wireless transmitting data using a contention-based protocol, wherein a plurality of communicating wireless terminals transmit data using a common medium for transmitting. The invention further relates to a terminal for wireless transmitting data packets using a contention-based protocol, including a transmitting and receiving unit and a controller.

The number of different wireless communication standards has increased in the last years, leading to a tremendous boost in sales of wireless devices. The amount of spectrum available for wireless transmission, however, is limited, and every device occupying part of the spectrum temporarily, potentially interferes with other devices and possibly on-going communication.

The number of voices demanding a worldwide “spectrum-etiquette” ruling the use of the scarce resource “spectrum” is increasing. Industry associations such as the IAG (Industry Advisory Group), but also standardization bodies such as ETSI in Europe and IEEE in the US are aware of the up-coming interference problem, and have initiated investigations on how to counteract with it. Specifically in the ISM (Industrial, Scientific and Medical) frequency bands, the problem will become apparent on short term.

Many wireless communication systems rely on contention-based access to the medium: as an example, the IEEE 802.11 protocol is based on the CSMA/CA principle (Carrier-Sense-Multiple-Access/Collision-Avoidance). In the protocol 802.11 every wireless terminal has to wait for the medium to become idle before attempting to access the medium. Starting with the observation of the medium being idle, each wireless terminal has to wait for an individual waiting time, in the following denoted as back-off time before it may start its first attempt to access the medium. If no communication attempt from another wireless terminal or an access point has occurred until the back-off time is elapsed, the medium may be accessed. Obviously, wireless terminals with shorter back-off times have, on average, a larger chance to access the medium than those with longer back-off times. If, however, two wireless terminals access the medium at the same time, be it because their back-off value is identical, or they have a different perception of events in the network, a collision occurs. Once this has happened, each affected terminal backs off again by using its individual back-off time, before it may start a second attempt to access the medium.

In a number of variants to the standard, dedicated use is made of these back-off times: e.g. the QoS (Quality-of-Service) extensions specified in the upcoming IEEE 802.11e standard use shortest back-off time for an enhanced access point, the so-called hybrid coordinator, in order to give this device highest priority in accessing the medium. Sophisticated algorithms are possible to adjust back-off times and back-off time windows, wherein the window specifies the range of possible back-off times for a wireless terminal, including a fixed and a random part, in order to fine-tune priorities. However, none of these methods to adjust the back-off times has been tuned to optimise the use of the spectrum. Although a need for spectrum etiquette has been identified, enforcement rules have not yet been formulated.

Therefore, it is an object of the present invention to provide a method and a system allowing to optimise the use of spectrum in contention-based protocols and to decrease the overall emitted power used for transmitting data packets and decrease the overall interference between wireless communication systems.

This object is solved by the features given in the independent claims.

The invention is based on the thought that by using a rewarding scheme for wireless terminals transmitting with low transmit power, the amount of overall emitted power, and consequently the level of interference, and amount of spent energy as well, could be reduced. Since a transmission of data using high transmit power will interfere other transmission between close wireless terminals the interference of the transmission may result in unsuccessful transmissions between those terminals, which need to be repeated and thereby again occupying the respective frequency band thus rendering an inefficient usage of it. If the wireless terminals transmit with low transmit power the risk of an unsuccessful transmission for other adjacent terminals is decreased. However, also the coverage range of the currently transmitting terminal is decreased, and depending on the distance between this sending terminal and the receiving terminal the chance of successful transmission for this terminal may be reduced. Hence, an optimisation is needed such that only the minimum amount of transmit power required for a message to reach its destination is used.

In particularly it is proposed to register an amount of used transmit power and to adjust features of a wireless terminal to reward the wireless terminal in dependence of the used transmit power.

Thus a rewarding scheme is proposed for those wireless terminals that cause least interference to their environment, by coupling features of the wireless terminals to the amount of transmit power used in transmission. These features will affect the time necessary to access the medium. In the present case the medium is the frequency band.

In a preferred embodiment of the invention the wireless terminals which have been or are using low transmit power are allowed to reduce their back-off time and/or to increase the priority of the data packet to be transmitted, whereas those having used or using high transmit power have to increase their back-off time and/or not to increase the priority of the data packets to be transmitted next.

By this, the inventive method biases the chance of wireless terminals to gain access to the medium towards those with lower transmit power, and thus reduces the overall emitted power. The inventive method using the rewarding scheme results in a new dimension for optimisation. So, depending on the rewarding algorithm, a wireless terminal experiences higher medium access chances from its “well-behaviour” in the past.

A further advantage of reducing of the overall emitted power is the improvement of the quality of service and thereby the increasing successfully transmitted data throughput.

The current inventive method, however, proposes a simple, local enforcement mechanism suitable for selfishly operating wireless terminals. The method is easy to implement in existing and future devices, since only the method for determining the back-off time and/or the priority needs to be changed. The required registration of the amount of used transmit power is available within the wireless terminal. So, this used transmit power value needs to be considered in determining the back-off time or priority of the data packet to be transmitted next.

In a preferred embodiment of the present invention it is advantageously proposed to determine the back-off time of the wireless terminal and/or the priority of the data packet in dependence of the used transmit power of a last transmitted data packet, which is sent within a predefined maximum time interval of e.g. 500 milliseconds. A further criterion could be an average transmit power used for all data packets transmitted within a predefined time interval (e.g. the last 1000 milliseconds). Further the maximum used transmit power for a data packet within a predefined time interval (e.g. the last 500 milliseconds) could be used.

In a further preferred embodiment of the present invention the amount of energy used for transmission is used as further optimising criteria. This will also include the amount of energy used for a retransmission of data packets if a first transmission failed. An example implementation could make use of the so-called energy efficiency, which can be formulated as follows:

$$J [ k ] = \frac{G [ k ]}{E}$$

k: packet index

G[k]: successful net throughput (e.g. number of information bits in the packet)

E: total energy required for transmission of the currently transmitted packet ‘k’.

Once having the energy efficiency calculated it could be used for determining the back-off time or priority of the data packet. In particularly the energy efficiency J of the last data packet which is sent within a predefined maximum time interval of e.g. 500 milliseconds or an average energy efficiency for all data packets within a predefined time interval (e.g. the last 1000 milliseconds) or the minimum energy efficiency for a data packet within a predefined time interval (e.g. the last 500 milliseconds) could be used for determining the back-off time of the wireless terminal and/or the priority of the data packet.

In a further preferred embodiment the relation between the amount of used transmit power and the back-off time is determined in dependence on the application. For determining the back-off time a linear or a logarithmic or any suited monotone increasing function could be used. It is further possible to use a look up table for assigning the respective back-off times for used transmit power in the past.

In an advantageous embodiment thresholds are used for determining the back-off time of a wireless terminal. If a transmit power is used by a wireless terminal lying over a predetermined threshold the back-off time will be set to a large value to “punish” the wireless terminal in getting access to the medium for the forth-coming transmissions. Contrariwise, in case a transmit power is used by a wireless terminal lying below a predetermined threshold the back-off time will be set to a low value to “reward” the wireless terminal in getting access to the medium for the coming transmissions.

Since each data packet to be transmitted has a priority value assigned a further possibility to reward a wireless terminal could be to increase virtually the priority value of a data packet in dependence of the used transmit power. So the medium will see the higher priority value, wherein the receiving terminal will see the real priority value. By this a data packet having a higher priority value should be earlier transmitted than a data packet having a lower priority value. There is also the possibility to combine the adjustment of the back-off time of a wireless terminal and the setting of the priority value in dependence of the used transmit power.

In a further preferred embodiment of the invention a wireless terminal using a multi-hop communication to reach a faraway wireless terminal is rewarded with a decreased back-off time or an increased priority of the data packets to be transmitted next. The multi-hop communication uses a terminal located between faraway terminals as intermediate terminal. The terminal will act as repeater. Since the transmit power required to transmit data to the intermediate terminal is lower than that needed for transmitting the data directly to the receiving terminal, the amount of overall emitted power and the used transmit power are reduced, thereby decreasing the risk of interference of adjacent communications.

The object of the present invention is also solved by a terminal for wireless transmitting data packets using a contention-based protocol, including a transmitting and receiving unit and a controller, means for registering the used transmit power for transmitting data packets and means for determining features of the wireless terminal to enhance the chance to get access to the medium in dependence of the used transmit power.

Preferred embodiments of the invention are described in detail below, by way of example only, with reference to the following schematic drawings.

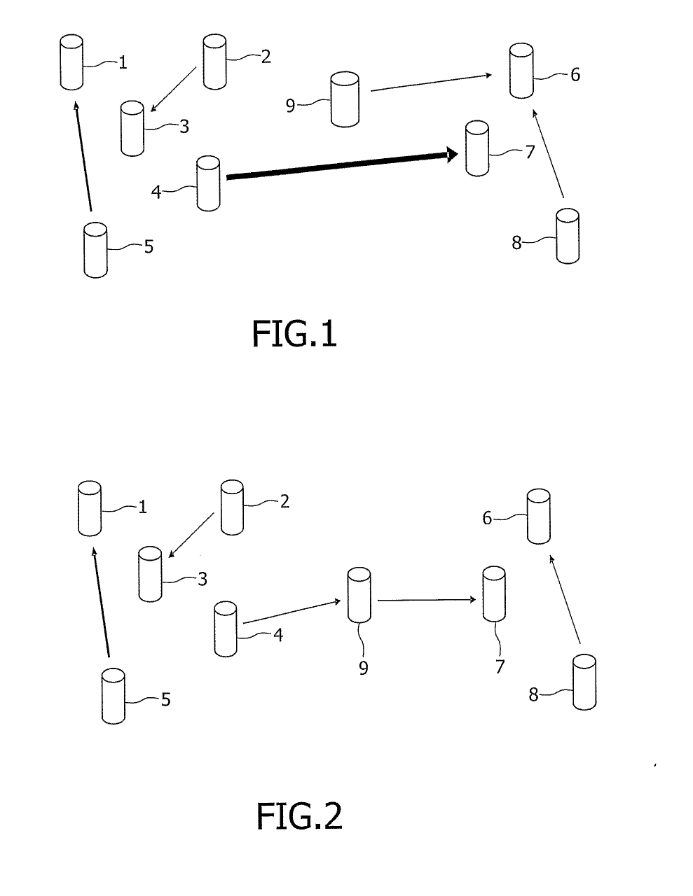

FIG. 1 illustrates a scheme for the situation without using the present invention;

FIG. 2 illustrates a scheme according the present invention;

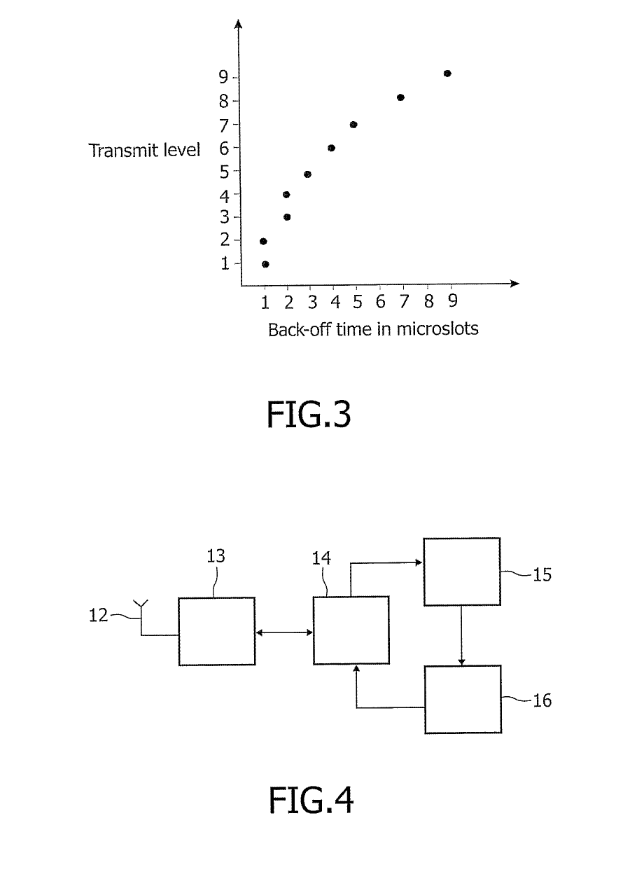

FIG. 3 shows a mathematical function for mapping of back-off times according the present invention;

FIG. 4 shows a system using the rewarding scheme according the present invention;

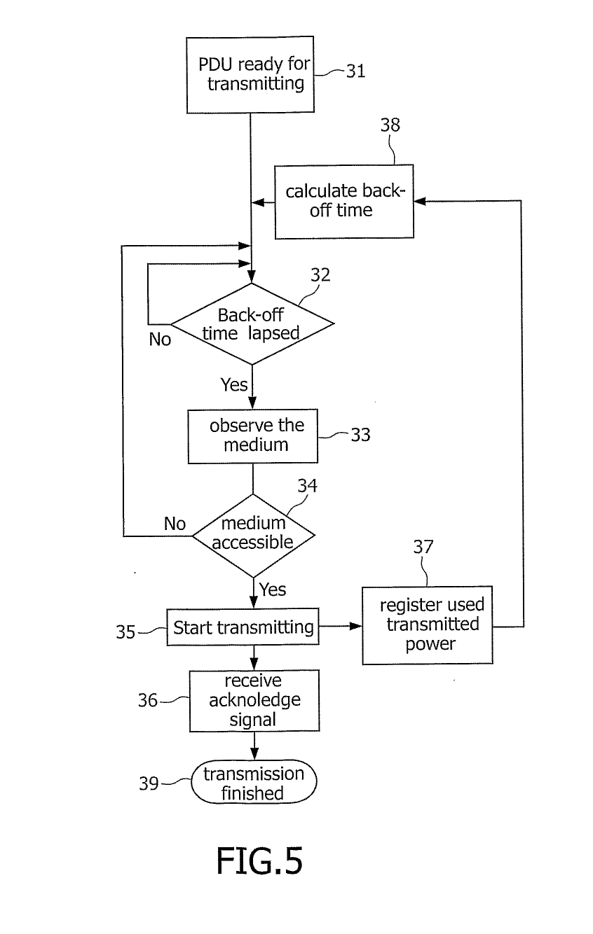

FIG. 5 shows a flow chart for determining the back-off time according the present invention;

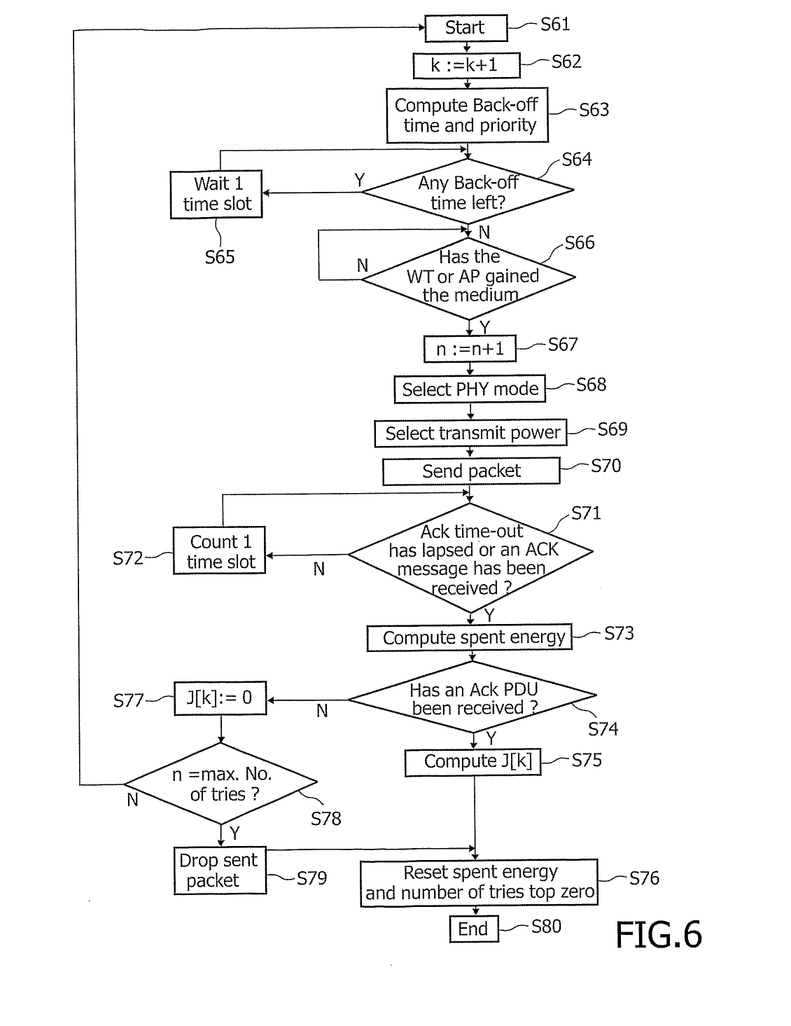

FIG. 6 shows a flow chart for calculating the energy efficiency;

The drawings are provided for illustrative purpose only and do not necessarily represent practical examples of the present invention to scale.

In the following the various exemplary embodiments of the invention are described.

Although the present invention is applicable in a broad variety of applications it will be described with the focus put on IEEE 802.11 WLANs, wherein also an implementation within the Bluetooth or the emerging UWB Standard (IEEE 802.15.3a, Wireless PAN with Ultra-Wideband physical layer technology) is possible.

Before embodiments of the present invention are described, the known starting situation will be described in FIG. 1.

FIG. 1 shows a plurality of communicating wireless terminals. The wireless terminals are denoted with reference signs 1-9. The wireless terminals 1-9 are connected via a not illustrated access point, which is coordinating the communication between the wireless terminals. The access point defines the range of parameters which could be used by the wireless terminals 1-9 for wireless communicating. The upper limit of transmit power is specified by the usage regulations for each frequency band by the national regulatory body. A different mode to communicate is to communicate directly between two wireless terminals, wherein also in this mode the access point will set the parameters and announce the participating terminals.

Thin arrows, e.g. between terminal 2 and 3, indicate low transmit power levels, wherein thicker arrows, e.g. between terminal 1 and 5 indicate higher transmit power levels. Referring to FIG. 1, the communication between terminal 2 and 3 is disturbed by the high transmit power communication between terminal 5 and 1. The terminal 5 transmits with unnecessary high power levels. Furthermore, the reception at terminal 3 is heavily disturbed by the high transmit power used by terminal 4 in order to reach terminal 7. Although, in order to bridge the large distance between terminals 4 and 7, such a high transmit power level may appear necessary, from a spectrum efficiency point of view this situation is undesirable. This situation is solved by using the inventive method as illustrated in FIG. 2.

Referring to FIG. 2, instead of transmitting at such a high power and thereby ‘polluting’ the local environment affecting terminals 1, 2, 3 and 5, the transmission between terminals 4 and 7 should preferably utilise the forwarding terminal 9 in between (i.e. make use of multi-hop communication). This forwarding terminal 9 acts as repeater and may use a lower transmit power level. Since terminal 9 is closer to terminal 4 than terminal 7, also terminal 4 can now transmit using less transmit power. The use of forwarding terminal 9 will affect the ability of this terminal 9 to transmit or receive own traffic, however in respect to transmission standards having high capacities the sharing of this ability could be put up easily.

FIG. 3 represents a mathematical function used for determining the back-off time of a wireless terminal for following transmission. The transmit level is indicated as number of transmit power steps, and the power-related dynamic part of the back-off time is indicated as number of micro-slots (i.e. the granularity of back-off time). To calculate the back-off time the amount of used transmit level is observed. If a wireless terminal has transmitted the last data packet with a transmit level of 1, it will be rewarded by assigning a back-off time for the next transmission of 1 micro slot, wherein a micro slot represents the smallest unit or granularity of the back-off time. So, by using a low transmit level this wireless terminal will get a high chance to access the medium very fast again, because its back-off time is set very low. A further example will show the contrary situation. If a wireless terminal has transmitted its last data packet with the highest possible transmit level of 9 it will be punished for the following transmission by assigning a back-off time of 9 micro slots. Independently which transmit level is used by this wireless terminal for the next transmission after trying to access the medium and in the case of a collision it will be back off again for 9 micro slots, so it has to wait. Other wireless terminals having smaller back-off times will have a higher chance to access the medium.

The function shown in FIG. 3 depicts one possibility only to determine the back-off times in dependence of the used transmit power. Many more implementations are possible, supporting e.g. specifically transmissions for streaming applications. A combination of the low-power-rewarding mechanism with the QoS extensions defined in IEEE 802.11e would surely yield a superior combination of spectrum efficiency and QoS performance.

FIG. 4 represents a part of a terminal for wireless transmitting data packets using a contention based MAC protocol. The illustrated part of the terminal could be implemented within a notebook or a PDA or the like which is able to communicate e.g. via a WLAN. The terminal comprises an antenna 12 for transmitting and receiving signals. A receiving and transmitting unit 13 performs the respective steps to receive or transmit the data packets, which are also known as PDUs within the WLAN standards. The data packets are generated by a controller 14. The controller 14 could be realised as processor on a WLAN stick or add-on card, or as a main processor of a notebook capable to communicate via WLAN. The means for registering the used transmit power are denoted with reference sign 15. Since the controller 14 controls the transmit power to be used for transmitting data packets, this used transmit power value has to be registered by means 15. Having this used transmit power values registered they are provided to means 16 for determining the back-off time for the next transmission. Within the means 16 for determining the back-off time the mathematical function is implemented by using a respective formula or a look-up table. Also further parameters could be considered in determining the back-off time, e.g. the ability of a terminal to perform directed transmission, thereby reducing the chance of interfering with other ongoing communication to a geographically strictly limited area; another example for a useful parameter is the current function a terminal currently operating as forwarding terminal for other traffic.

FIG. 5 represents a flow chart illustrating the procedure according the present invention. After the PDU is composed to be transmitted in step 31 the wireless terminal will wait for lapse of the back-off time (step 32). If the back-off time is lapsed the medium will be observed (step 33) if it is accessible or not. It is noted for completeness that also during the back-off time (step 32) the medium is observed, and if busy, back-off starts again; however, this is a standard feature in e.g. IEEE 802.11 WLANs. If the medium is accessible (step 34) the transmission will be started in step 35. If the medium is occupied the wireless terminal has to wait the back-off time again (step 32) and try again to access the medium. After starting the transmission (step 35) the used transmit power is registered by means 15 (step 37). The spent transmit power value is used for calculating the back-off time for next transmission (step 38). If the used transmit power exceed a predetermined threshold the back-off time will be increased for the next transmission. If the used transmit power remains below the predetermined threshold the back-off time will be decreased to thereby increase the chance to access the medium for the next transmission. After having started the transmission (step 35) the acknowledge signal needs to be received (step 36) from the receiving terminal, then the transmission is successfully finished (step 39). If the transmission failed it has to be repeated.

FIG. 6 illustrates a flow chart for calculating the energy efficiency J[k]. In step S61 the procedure for calculation of the energy efficiency J[k] is started. In step S62 the variable k is incremented by 1. In step S63 the energy efficiency J[k] is calculated depending on the number of transmissions and the previously used values of the energy efficiency. In step S64 it is checked whether any back-off time is left. If the back-off time is not lapsed the wireless terminal has to wait one time slot more (step S65). If the back-off time is over it is checked in step S66 whether the wireless terminal WT or the access point AP has gained the medium. If the wireless terminal WT or the access point AP has gained the medium the variable n (number of transmissions) is incremented by 1 in step S67. In step S68 the PHY mode is selected, wherein PHY means physical layer. The PHY mode is a combination of modulation scheme, modulation constellation, channel coding scheme and transmit power range which radio systems incorporate to offer the user different data rates, degrees of robustness against interference offering adaptivity to different traffic sources and channel status. For instance, for the IEEE 802.11a case, and for 802.11 g as well, there are 8 different PHY modes available. It uses OFDM (Orthogonal Frequency Division Multiplexing) as the only modulation medium-access scheme, 4 different modulation constellations and 3 different code rates for a convolutional code-based channel coding which yield 8 different maximum data rates, illustrated in the following table

| | | Convolutional | |
|---|---|---|---|
| PHY Mode | Modulation | Code Rate | Data Rate [Mbps] |
| 1 | BPSK | ½ | 6 |
| 2 | BPSK | ¾ | 9 |
| 3 | QPSK | ½ | 12 |
| 4 | QPSK | ¾ | 18 |
| 5 | 16 QAM | ½ | 24 |
| 6 | 16 QAM | ¾ | 36 |
| 7 | 64 QAM | ⅔ | 48 |
| 8 | 64 QAM | ¾ | 54 |

with BPSK (Binary Phase Shift Keying), QPSK (Quadrature Phase Shift Keying) and QAM (Quadrature Amplitude Modulation).

In step S69 the transmit power is selected. In step S70 the packet is sent. In step S71 it is checked whether the time for waiting of the acknowledgement PDU has lapsed or an ACK message has been received. If the acknowledgement time-out is not lapsed or no ACK message has been received a further time slot will be counted in step S72. If the acknowledgement time-out is elapsed or an acknowledgement PDU has been received the total amount of transmission energy spent will be calculated in step S73. The spent energy depends on length of the packet, on the PHY mode and on the transmit power, but may also include the base-band processing energy needed for the last transmission attempt. In step S74 it is checked whether the acknowledge PDU has been received. If the acknowledge PDU has been received the transmission is successfully completed. In that case, the energy efficiency J[k] is calculated in step S75. Once the energy efficiency J[k] has been computed, both, the value for the spent energy and the number of transmissions, n, are reset to zero. The calculated value for the energy efficiency J[k] is used in the next pass of the flow chart to determine the back-off time and/or the priority for a wireless terminal. If the acknowledge PDU has not been received in step S74 the procedure will continue with step S77, wherein the energy efficiency J[k] is set to zero. In step S78 it is checked whether n is equals to the maximal number of tries. If the maximal number of tries has been reached the sending is stopped in step S79. The routing table could be altered, if last J[k] readings are low on average. If the maximal number of tries is not reached the procedure will step back to the start step S61 to restart the calculation of the energy efficiency.

By using this procedure illustrated in the flow chart according FIG. 6 a suitable method is provided to evaluate the transmit power for the successful transmissions as well as the used transmit power for the failed transmissions.

1. Method for wireless transmitting data using a contention-based protocol, wherein a plurality of communicating wireless terminals (1-9) transmit data using a common medium for transmitting, the method within a wireless terminal comprises the steps of:
waiting for a back-off time to access the medium,
observing whether the medium is idle,
transmitting the data if the medium is idle,
registering an amount of used transmit power,
adjusting features of the wireless terminal to reward the wireless terminal in dependence of the used transmit power.

2. Method as claimed in claim 1, wherein the back-off time of the wireless terminal and/or a priority of a data packet to be transmitted are determined in dependence of the amount of used transmit power.

3. Method as claimed in claim 1, wherein the back-off time of the wireless terminal and/or the priority of the data packet are determined in dependence of:
the used transmit power of a last transmitted data packet or
an average transmit power for all data packets within a predefined time interval or
the maximum used transmit power for a data packet within a predefined time interval.

4. Method as claimed in claim 1, wherein the step of registering the amount of used transmit power comprises further:
determining a energy efficiency J according the formula
$$J [ k ] = \frac{G [ k ]}{E} ,$$
wherein k being a packet index, G[k] being a successful transmitted throughput, and E being the total energy required for transmission of the currently transmitted packet ‘k’; and
using the energy efficiency J[k] of the last data packet or an average energy efficiency for all data packets within a predefined time interval or
the minimum energy efficiency for a data packet within a predefined time interval for determining the back-off time of the wireless terminal and/or the priority of the data packet.

5. Method as claimed in claim 3, wherein the time interval includes the time for transmitting the data packet and the time for transmitting the acknowledge signal in return.

6. Method as claimed in claim 1, wherein the relation between transmit power and/or energy efficiency J[k] and the back-off time or priority of the data packet to be derived thereof is a predetermined mathematical function, which is set according the application.

7. Method as claimed in claim 1, wherein the back-off time of a wireless terminal is decreased, if the amount of used transmit power is below a predetermined threshold.

8. Method as claimed in claim 1, wherein the priority of a data packet to be transmitted is increased if the wireless terminal has transmitted the preceding data packet with a transmit power below a predetermined threshold.

9. Method as claimed in claim 1, wherein a wireless terminal using a multi-hop communication to reach a faraway wireless terminal is rewarded with a decreased back-off time or an increased priority of the data packets to be transmitted next.

10. Terminal for wireless transmitting data packets using a contention-based protocol, including a transmitting and receiving unit (13) and a controller (14), means for registering (15) the used transmit power for transmitting data packets and means for determining features (16) of the wireless terminal to reward the wireless terminal in dependence of the used transmit power.
